(19) United States
(12) Patent Application Publication
(10) Pub. No.: US 2018/0116238 A1
(43) Pub. Date: May 3, 2018

(54) MIXTURE AND FOOD PRODUCT LOW IN POTASSIUM, SODIUM AND PHOSPHORUS

(71) Applicant: Nutrimentos Inteligentes S.A. de C.V., Guadalajara, Jalisco (MX)

(72) Inventors: Fabiola Martin Del Campo Lopez, Guadalajara, Jalisco (MX); Luis Gerardo Gonzalez Delgado, Guadalajara, Jalisco (MX)

(21) Appl. No.: 15/568,423

(22) PCT Filed: Apr. 20, 2015
(86) PCT No.: PCT/MX2015/000065

§ 371 Date: Oct. 20, 2017

(51) Int. Cl. A23C 11/10; A23L 2/38; A23L 33/00; A23L 33/19; A23L 33/16; A23L 27/30; A23L 29/238; A23L 29/269; A23L 25/00; A23L 5/00; A23L 7/10

(52) U.S. Cl. CPC A23C 11/103; A23L 2/38; A23L 33/40; A23L 33/19; A23L 33/16; A23V 2002/00; A23L 29/238; A23L 29/269; A23L 25/20; A23L 5/00; A23L 7/198; A23L 27/33

(57) ABSTRACT

The purpose of the present report is to provide a mixture that includes a combination of rice flour, protein isolate, and/or almond, to be consumed, preferably, by patients with kidney disease.

Another purpose of this invention is a food product low in potassium, sodium and phosphates, that is obtained from the previously described mixture, which is useful to be consumed, preferably, by patients with kidney disease.

Another purpose of the invention is a milk substitute low in potassium, sodium and phosphates, obtained by the previously described mixture, which is useful to be consumed, preferably, by patients with kidney disease—

An additional purpose of the invention is the usage of the mixture to prepare a food product as a milk substitution, low in potassium, sodium and phosphates, to be consumed preferably, by patients with kidney disease.

Also, another purpose of this invention is to provide a production process of a mixture that includes a combination of rice flour, protein isolate, and/or almonds, to prepare a food product as a milk substitution, low in potassium, sodium and phosphates, to be consumed preferably, by patients with kidney disease.

### TECHNICAL FIELD OF THE INVENTION

This invention is related with Nutrition, Food technology and Medicine fields since it describes a mixture and food product low in potassium, sodium and phosphorus to be consumed, preferably, by patients with kidney disease.

### PURPOSE OF THE INVENTION

One purpose of this invention is to provide a mixture that includes a combination of rice flour, protein isolate, and/or almonds, to be consumed, preferably, by patients with kidney disease.

Another purpose of this invention is a food product that is low in potassium, sodium and phosphates, obtained by the previously mentioned mixture and which is useful to be consumed, preferably, by patients with kidney disease.

Another purpose of the invention is a milk substitute low is potassium, sodium and phosphates, obtained by the previously describe mixture, which is useful to be consumed, preferably, by patients with kidney disease.

An additional purpose of the invention is the usage of the mixture to prepare a food product as a milk substitution, low in potassium, sodium and phosphates, to be consumed, preferably, by patients with kidney disease.

Also, another purpose of this invention is to provide a production process of a mixture that includes a combination of rice flour, protein isolate, and/or almonds, to prepare a food product as a milk substitution, low in potassium, sodium and phosphates, to be consumed preferably, by patients with kidney disease.

### PRIOR ART

Kidney disease is a globally public health concern, with a constant increase in the number of patients that suffer it, including those who require a kidney replacement therapy. Kidney disease is a high health problem not only for its high prevalence, but also for the disorders next to it, mostly hyperkalemia, hyperphosphatemia, protein-energy malnutrition, among others. All this conditions, beyond increasing morby-mortality rate, make medical and nutritional treatments to be very complex. Consequently, it is the nutritionist's duty not only to maintain a good nutrition status, but also to avoid the development of the previous mentioned disorders. Thus, it is highly important to take care of the nutrients and food offered and/or included in the diet of patients with kidney disease.

One of the main purposes of the nutritional treatment of the patient with kidney disease is to maintain under control the electrolytes and minerals abnormalities, especially of potassium (hyperkalemia, phosphates (hyperphosphatemia) and sodium, as well as the consequences followed by those abnormalities, for instance, heart arrhythmia and sudden death due to hyperkalemia, bone decalcification, vascular calcification due to hyperphosphatemia, as well as arterial hypertension and fluid retention due to a sodium intake excess. That is why, it is frequently necessary to make food restrictions with high content of this minerals (mainly cow milk and milk beverages), giving rise to monotonous and very limited diets, which makes even harder the treatment's attachment, furthermore, the patient's poor appetite makes diet even more limited impacting the nutrition status and life quality directly.

Despite these dietary restrictions, for several reasons, there are a high number of patients with kidney disease who continue to use cow milk and milk beverages. Beside of being taken for its flavor, habit or cultural relevance, cow milk can easily be used to improve the nutrition status when it's combined with much other food (increase of energy density), especially with poor appetite patients, young children or elders.

Due to their ingredients, characteristics and/or nutritional composition, there are currently in the market food products that are considered appropriate for patients with kidney disease because they are usually low in potassium, phosphates and sodium. An example of which is the milk substitutes made of flour, rice, soy or almonds, and infant formula for first stage. Nevertheless, those products were not specifically designed for patients with kidney disease, and in some cases, the content of potassium, phosphates and sodium is not shown, resulting consequently, the intake for this type of population to be controversial.

Based on the current available information in regards to milk substitutes, it seems that almond beverages of Blue Diamond's Almond Breeze® and rice beverages of Rice Dream Original® and Kirkland® brands, could be considered as the best option to change cow milk intake for patients with kidney disease, for the lowest reported content of phosphates and potassium in comparison with the other brands. However, these beverages doesn't have any protein content and the intake isn't recommended preferably, for patients with kidney disease in dialysis stage.

Also, organoleptic properties of these substitutes aren't similar to cow milk, especially with consistency, color and flavor, causing the diet attachment even more difficult. When it comes to milk substitutes combined with other ingredients made of rise, soy or almonds, there is only one identified beverage made of rice and almonds (La Finestra sul Cielo®) made in Spain. Nevertheless, there isn't any report of the content of phosphates or potassium in this beverage and the usage for kidney disease would be under discussion.

According the report's stage, patents CN101703291 B and CN101536804 B describe beverages made of brown rice and puffed rice respectively. The request of patent CN1820655 describes a beverage based of bitter almond and soybeans. The inconvenient of these documents is that the content of protein, potassium, sodium or phosphates isn't reported. Patent AU 2006263651 B2 describes a food composition low in protein (10-20%), potassium (0.1-0.5%) and sodium (0.1-0.5%) in preventing or treating patients with kidney disease, in which the veterinary purpose preferably, with canines and felines is the main application. This patent doesn't hint the composition's organoleptic properties, this casts doubt on the acceptance from patients with kidney disease.

For all mentioned above, a mixture of rice flour, isolate protein, and/or almond was created to make a food product, as a milk substitute, low in potassium, sodium and phosphates to be consumed preferably by patients with kidney disease.

### FIGURES BRIEF DESCRIPTION

FIG. 1 is a block diagram that shows the production process of a mixture that includes a combination of rice flour, protein isolate, and/or almonds to prepare a food product as a milk substitution, low in potassium, sodium and phosphates.

FIG. 2 is a graph that shows the perception behavior of the flavor for 4 types of milk substitutes in patients with kidney disease.

FIG. 3 is a graph that shows the perception behavior of the smell for 4 types of milk substitutes in patients with kidney disease.

FIG. 4 is a graph that shows the perception behavior of the consistency for 4 types of milk substitutes in patients with kidney disease.

FIG. 5 is a graph that shows the perception behavior of cow milk flavor similarity with 4 types of milk substitutes in patients with kidney disease.

FIG. 6 is a graph that shows the perception behavior of cow milk color similarity with 4 types of milk substitutes in patients with kidney disease.

FIG. 7 is a graph that shows the perception behavior of cow milk consistency similarity with 4 types of milk substitutes in patients with kidney disease.

FIG. 8 is a graph that shows the preference behavior of 4 types of milk substitutes in patients with kidney disease.

### DETAILED DESCRIPTION OF THE INVENTION

This invention gives a mixture that includes a combination of rice flour, protein isolate, and/or almond, to prepare a food product as a milk substitute, low in potassium, sodium and phosphates. It is highly recommended to use ingredients made of rice and/or almonds because they present the best nutritional profile for patients with kidney disease due to the low content of sodium, phosphates and potassium; beside, they are naturally lactose free, as well as saturated fat and cholesterol.

For one creation type of this invention, the almond is sweet (Prunus dulcis) preferably in pieces. The protein isolate in the other hand, provides biological high level protein. It can be animal or plant origin. For one creation type of this invention, the protein isolate is from plant origin, especially Fabaceae soy species (Glycine max) which has a lower phosphates level than cow milk. Also, soy is the only natural dietetic source from a polyphenols special group known as Isoflavones and which has the prevention of a cardiovascular disease as the first benefit for patients with kidney disease health.

The amount of rice flour for the mixture is 10-50%, 10-40% of protein isolate and 5-10% of almond. The mixture to prepare a food product as a milk substitute, also contain at least one vegetable oil, one sweetener and one thickening agent. The vegetable oil must contain >20% of monounsaturated fat, <10% of polyunsaturated fat and <7% of saturated fat. The sweetener can be natural or artificial. For one creation type of this invention, the sweetener is artificial, particularly sucralose, and the thickening agent is maltodextrine and guar gum.

One of the several applications that can use with this mixture, is the preparation of diverse food products types, as in liquid form (beverages, shakes, milk substitutes, yogurt) and solid form (powder, jelly, bakery and pastry products) just to mention a few, to be consumed preferably, by patients with kidney disease.

Therefore, this invention provides a food product that includes the previous mentioned mixture. This is low potassium, sodium and phosphates content food product. Potassium's content is less than 150 mg, less than 75 mg of sodium (25% less than cow milk), and less than 100 mg of phosphates. It contains at least 0.5 g protein, preferably between 0.5 and 10.0 g. This food product can be found in solid and liquid forms. For one creation type of this invention, the food product is in solid form, powder particularly.

Consequently, this invention includes a milk substitute that includes the previously mentioned mixture. This milk substitute has low potassium, sodium and phosphates content. The content of potassium is less than 150 mg, less than 75 mg of sodium (25% less than cow milk) and less than 100 mg of phosphates. Protein content of this substitute is 0.5 g at least, preferably between 0.5 and 10.0 g.

The milk substitute can be in found in solid and liquid form. For one creation type of this invention, the milk substitute is in solid form, powder particularly.

Also, making reference with FIG. 1, this invention provides a production process of the previously described mixture to make a food product as a milk substitute that is low in potassium, sodium and phosphates, which includes the following stages:

a) Weigh the previously described mixture's ingredients: 10-12% rice flour, 10-40% protein isolate, 5% almond, vegetable oil, thickening agent, and sweetener.

b) Sift the ingredients, this means that before the mixer, all the ingredients have to pass throughout meshes with a 20-25° C. temperature for 10 minutes to avoid foreign materials into the mixture. The sifting starts by getting a 6 grade mesh which will be removed after isolate protein passed through it, then, a 14 grade mesh is placed to finally get the rest of the ingredients passed through it in the following sequence: vegetable oil, rice flour, thickening agent, sweetener and almond.

c) Mix all the ingredients with a 20-25° C. temperature for a time lag of 25-30 minutes. The ingredients are added in the following sequence: protein isolate, vegetable oil, rice flour, thickening agent, sweetener and almond.

Evidence of this invention is shown by the following examples, which are preferential modalities of the process, thereby, they shouldn't be considered as a limiting condition of the invention.

Examples will be named next:

S1—Milk substitute made from rice flour

S2—Milk substitute made from soy

S3—Milk substitute made from almonds

S4—Milk substitute of this invention with rice, soy and almonds combination low in protein.

S5—Milk substitute of this invention with rice, soy and almonds combination high in protein.

### EXAMPLE 1

### Comparison Between Milk Substitutes

A compilation of the content averages of potassium, phosphates, sodium and proteins of three commercial milk substitutes and cow milk versus milk substitutes of this invention was made. The results are shown in Table 1.

As can be observed in Table 1, even when S2 and S3 substitutes show low phosphates content, the potassium content is still high and even similar to cow milk. S1 substitute for its part, shows potassium and phosphates low content; nevertheless, organoleptic properties, especially flavor and consistency, cannot be compared to cow milk (see Example 2). Compared to the rest of milk substitutes and cow milk, S4 and S5 substitutes show potassium and phosphates lowest content, beside, organoleptic properties are more similar to cow milk (see Example 2). In regards to sodium content, none of the milk substitutes except S4 and S5, show less than 25% compared to cow milk. Regarding protein content, S2 and S5 substitutes have a similar amount of protein with cow milk; but as mentioned before, S2 substitute has high potassium content.

Therefore, S4 and S5 milk substitutes are considered the best food option to change cow milk intake in patients with kidney disease.

TABLE 1
Averages content comparison of potassium, phosphorus, sodium
and protein between cow milk and milk substitutes.

| | Potassium | Phosphorus | Sodium | Proteins |
|---|---|---|---|---|
| | (mg) | (mg) | (mg) | (g) |
| Cow milk | 366 | 229 | 100 | 8.0 |
| S1 | 67 | 133 | 95 | 1.0 |
| S2 | 310 | 102 | 97 | 7.0 |
| S3 | 240 | 55 | 90 | 1.0 |
| S4 | 92 | 60 | 28 | 2.4 |
| S5 | 88 | 87 | 64 | 7.5 |

### EXAMPLE 2

### Organoleptic Properties Survey

A survey of organoleptic properties was applied to 60 patients with chronic kidney disease both in pre-dialysis (n=30) and in hemodialisis (n=30). Acceptance of S1-S5 milk substitute's tests was applied. In which flavor, smell and consistency acceptance of these products were valued. Also, comparison and preference tests were applied; in which patients were requested to order the tasted milk substitutes according their preference and similarity with regard to cow milk organoleptic properties (flavor, smell and consistency).

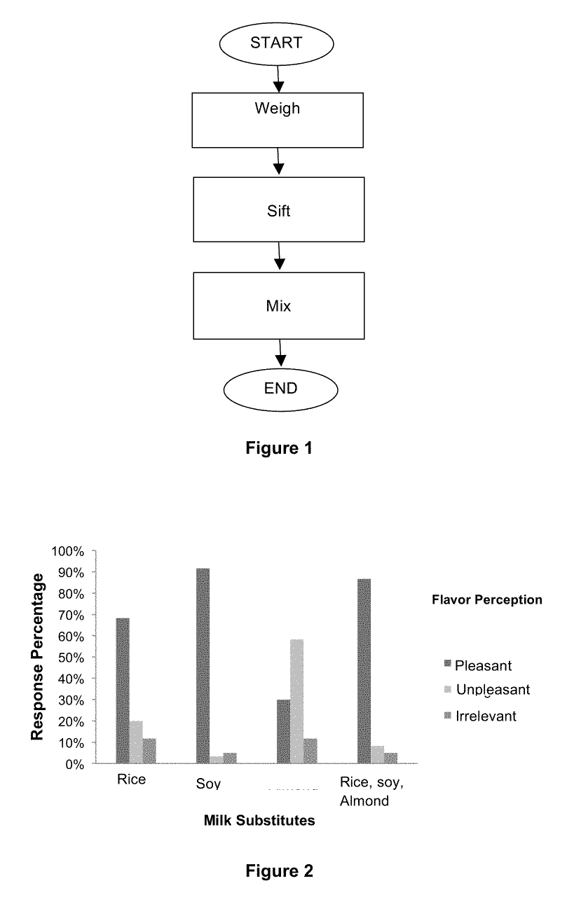

With the purpose of a better appreciation of the assessed characteristics, S4 and S5 results were added. Patients' average age was 44.8±20.7 years. Gender distribution was equal, 50% male patients and 50% female patients. Acceptance test results are shown in FIGS. 2, 3 and 4. Most of the patients considered S1, S2, S4 and S5 milk substitutes had a pleasant flavor. On the other hand, 58% of patients considered that S3 substitute had an unpleasant flavor as can be seen in FIG. 2.

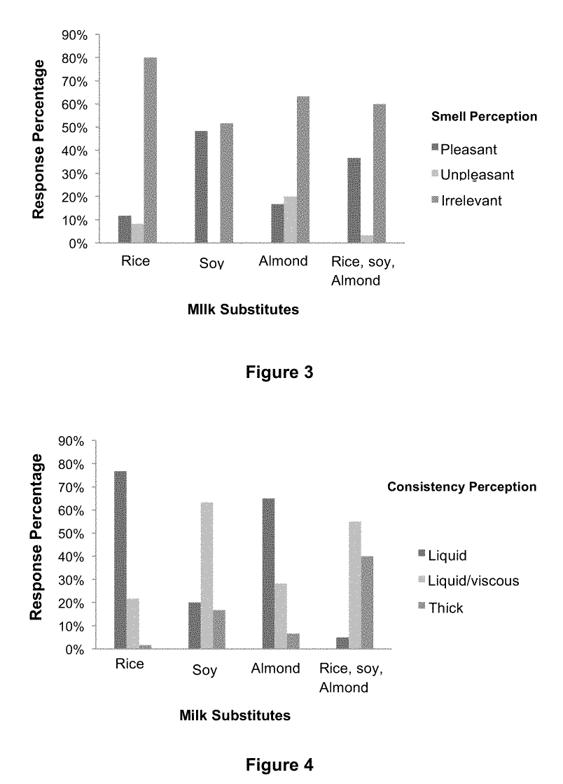

Regarding the smell property, most of the patients answered that the smell of milk substitutes was irrelevant, meaning that they didn't like or dislike it. It's also worth mentioning that almost all patients noticed a nice smell of S2, S4 and S5 milk substitutes as can be seen in FIG. 3.

As far of consistency property, 77% and 65% of patients considered S1 and S3 substitutes respectively, as liquid form (flavored water as example). While 63%, and 55% of patients noticed S2 and (S4+S5) milk substitutes respectively, as viscous liquid (milk as example) in reference with FIG. 4.

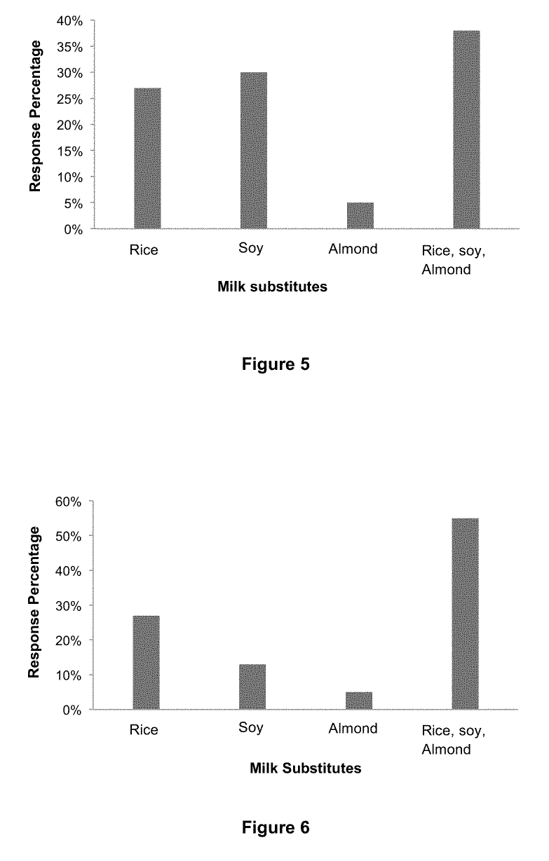

Results of comparison and preference's tests are shown in FIGS. 5, 6, 7 and 8. Almost all patients (38%) considered milk substitutes included in the mixture of this invention as the most similar flavor to cow milk, compared to S1, S2 and S3 milk substitutes that according to FIG. 5, had a 27%, 30% and 5% response percentage respectively.

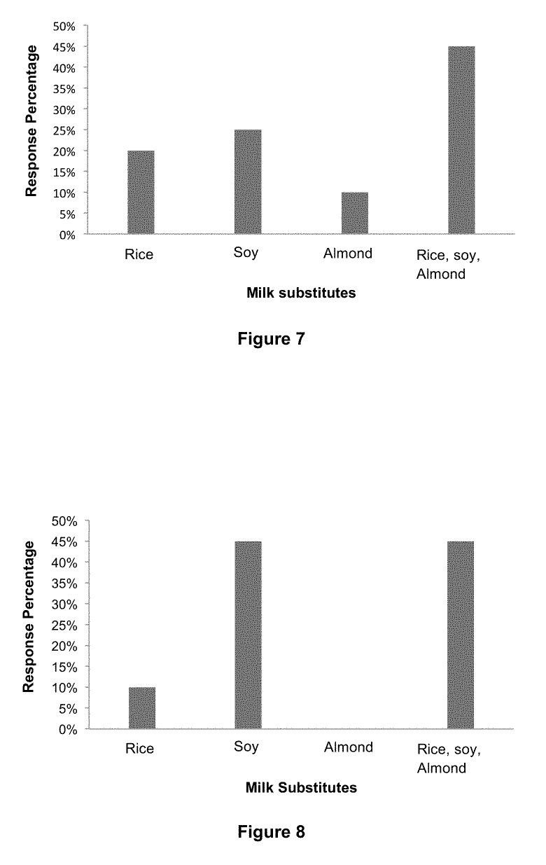

In contrast, most of the patients (55%) noticed that S4 and S5 milk substitutes presented the most similar color compared to cow milk, followed by S1, which obtained a response of 27% (FIG. 6). Likely, 45% of the patients answered that S4 and S5 milk substitutes has the most similar consistency with cow milk compared to the rest of the evaluated milk substitutes, in reference with FIG. 7.

Regarding the preference's test results, 45% of the patients preferred S2, S4 and S5 milk substitutes. The main reason why patients preferred them was because they presented a better flavor. None of the patients considered S3 as their milk substitute preference, as it can be seen in FIG. 8, it matches with the flavor perception results of this substitute, where most of the patients considered that it showed an unpleasant flavor.

According to the previously described results, S4 and S5 milk substitutes presented more similar organoleptic properties (flavor, color and consistency) to cow milk. Beside, these substitutes were totally accepted, particularly due to a nice flavor.

1. A mixture to prepare a food product comprising:
rice flour,
protein isolate, and
almond.

2. The mixture of claim 1, wherein the protein isolate is made of plant origin.

3. The mixture of claim 2, wherein a legume is the plant origin.

4. The mixture of claim 3, wherein soy is the legume.

5. The mixture of claim 1, where the almond is sweet almond.

6. The mixture of claim 1, wherein the amount of rice flour present in the mixture is 10-50%.

7. The mixture of claim 1, wherein the amount of protein isolate present in the mixture is 10-40%.

8. The mixture of the The mixture of claim 1, wherein the amount of almond present in the mixture is 5-10%.

9. The mixture of claim 1, where the almond is in a multiplicity of pieces.

10. The mixture of claim 1, further comprising at least one vegetable oil.

11. The mixture of claim 10, wherein the vegetable oil contains >20% monounsaturated fats, <10% polyunsaturated fats and <7% saturated fats.

12. The mixture of claim 1 further comprising at least one sweetener.

13. The mixture of claim 12, wherein the sweetener is artificial.

14. The mixture of claim 12, wherein sucralose is the sweetener.

15. The mixture of claim 1, further comprising at least one thickening agent.

16. The mixture of claim 15, wherein the at least one thickening agent comprises both maltodextrine and also guar gum.

17. A food product comprising a mixture comprising rice flour, protein isolate, and almond.

18. The food product according to claim 1, where the mixture comprises at least 0.5 g of protein content.

19. The food product of claim 18, wherein the mixture comprises at least 0.5 to 10.0g of protein content.

20. The food product of claim 17, wherein the mixture comprises less than 150 mg of potassium content.

21. The food product of claim 17, wherein the mixture comprises less than 75 mg of sodium content.

22. The food product of claim 17, wherein the mixture comprises less than 100mg of phosphorus content.

23. The food product of claim 17, wherein the food product has a solid form.

24. The food product of claim 23, wherein the food product has a powder form.

25. The food product of claim 17, wherein the food product has a liquid form.

26. The food product of claim 17, wherein the food product is a milk substitute.

27. A production process for producing a mixture to prepare a food product comprising:
a) weighing as ingredients to the mixture, rice flour, protein isolate, almond, vegetable oil, a thickening agent and a sweetener;
b) sifting the ingredients and passing the ingredients throughout meshes with a 20-25° C. temperature for 10 minutes in order to avoid foreign materials entering into the mixture the sifting commencing with a first mesh of small grade;
c) passing remaining ones of the ingredients throughout the a second mesh of larger grade in a sequence of first vegetable oil, then rice flour, then thickening agent, then sweetener and then almond; and,
d) adding the ingredients to a mixing container in a sequence beginning with the protein isolate, and continuing with the vegetable oil, then the rice flour, then the thickening agent, then the sweetener and finishing with the almond, and subsequently mixing the ingredients in the container with a 20-25° C. temperature for 25-30 minutes.

28.-31. (canceled)
